(19) United States
(12) Patent Application Publication
(10) Pub. No.: US 2025/0292191 A1
(43) Pub. Date: Sep. 18, 2025

(54) NEURAL NETWORKS TO MANAGE DELIVERIES

(71) Applicant: Amazon Technologies, Inc., Seattle, WA (US)

(72) Inventors: Varsha Shankar, Woodbridge (CA); Priyadevi Jayapal, Sammamish, WA (US); Shuang Kan, Thornhill (CA)

(21) Appl. No.: 18/608,532

(22) Filed: Mar. 18, 2024

(51) Int. Cl. G06Q 10/0833; G06F 40/58; G06Q 30/0201

(52) U.S. Cl. CPC G06Q 10/0833; G06F 40/58; G06Q 30/0201

(57) ABSTRACT

Systems and methods are disclosed for managing communication between a carrier and a recipient using neural networks. Systems use neural networks, performed by one or more processors, to identify triggers that are provided to the recipient based on information associated with a scheduled delivery. In response to initiating the contact, systems use neural networks, performed by one or more processors, to generate content for the recipient, where the content indicates issues of the scheduled delivery. The systems use neural networks, performed by one or more processors, to generate instructions for the carrier such that the carrier can complete the scheduled delivery.

### BACKGROUND

Using software algorithms and real-time data to coordinate delivery processes, computer systems and computer networks enable the operations of delivery services. These technologies are useful for determining optimal delivery routes, matching delivery requests with suitable carriers, and adapting to the dynamic challenges of urban logistics (e.g., traffic) and varying customer demands.

These systems may be challenged when detecting situations that warrant initiating communication between carriers and recipients due to issues during delivery. For example, a carrier and recipient can use software and a computer network to coordinate delivery of a package, but the carrier and recipient may speak different languages, or the carrier may not be able to view their communication device (e.g., mobile phone) when driving in order to receive instructions from the recipient. This difficulty can result in a surplus of unnecessary alerts or direct phone calls, creating inconvenience for both carriers and customers, or a failure to send timely alerts, which impacts the reliability of the service and customer satisfaction. Also, inefficient use of system resources, such as processing and managing a large number of irrelevant and untimely alerts, can consume significant computational power and data bandwidth. Accordingly, there exists a need to improve software, devices, and computer networks to address issues in delivery networks.

### BRIEF DESCRIPTION OF THE DRAWINGS

Various techniques will be described with reference to the drawings, in which:

FIG. 1 illustrates a schematic diagram including an example system that establishes contact between carriers and customers using neural networks, according to at least one embodiment;

FIG. 2 illustrates a block diagram including an example system that generates trigger events to establish contact between carriers and customers using neural networks, according to at least one embodiment;

FIG. 3 illustrates a block diagram including an example system that generates contents and instructions after establishing contact between carriers and customers using neural networks, according to at least one embodiment;

FIG. 4 illustrates a block diagram including an example system that performs neural network training, according to at least one embodiment;

FIG. 5 illustrates a call-flow diagram in which contacts are managed using neural networks, according to at least one embodiment;

FIG. 6 illustrates an example process to establish contact between carriers and customers using neural networks, according to at least one embodiment;

FIG. 7 illustrates another example process to initiate contact between carriers and customers using neural networks, according to at least one embodiment;

FIG. 8 illustrates an example of executing a scheduled delivery, according to at least one embodiment; and

FIG. 9 illustrates a system in which various embodiments can be implemented.

### DETAILED DESCRIPTION

Systems and methods are described herein for managing contact with a recipient of a scheduled delivery using artificial intelligence (e.g., neural networks) to address issues related to the scheduled delivery. Managing contact may include initiating contact, establishing, enabling the exchange of messages in different mediums such as a phone call, audio message, notification, etc. In some examples, a system can receive context information that is relevant to scheduled deliveries, where the context information may include, but not be limited to, real-time weather conditions, traffic updates, local events, construction activities, and location of carriers (e.g., how many stops left until the scheduled delivery). The system can receive profile settings that are specific to the customer and the carrier of the scheduled delivery. Profile settings specific to the customer may include referred delivery times, locations, specific instructions for handling deliveries (e.g., building access code, instructions for handling animals, instructions for handling children, instructions for being safe), communication preferences, such as receiving updates via SMS, email, or in-app notifications, language preferences, etc. Profile settings specific to the carrier may include vehicle details, availability schedules, and areas of operation, preferences for types of deliveries and routes, language preferences, safety concerns, etc.

The system can use neural networks performed by processors to determine if a chat trigger should be generated. Specifically, the neural networks may use the profile settings that are specific to the customer and the carrier of the scheduled delivery and context information associated with the scheduled delivery to generate a chat trigger. The system may initiate a contact with the customer and send the chat trigger to the customer. The neural networks can determine the medium of contact or form of contact (e.g., chat, call, smartwatch, audio messages, notifications on a display, email, instant messaging). A contact medium refers to a software, method, channel, or devices through which communication or interaction takes place between individuals, software, neural networks, and/or organizations.

In various examples, the system can communicate with the customer via the contact medium. For example, the system may use neural networks performed by processors to generate virtual chatbots that are able to converse with the customer. Contents that are generated using the neural networks while communicating with the customer may include text, videos, images, etc. The system may use the same, separate, or portions of neural networks to perform language translation and audio transcription. Those are to identify any issues of the scheduled delivery to be resolved or addressed such that carriers can complete the scheduled delivery. The issues may include, for example, a problem with accessing door, opening gate, pets, language, etc.

In some examples, the system may use neural networks, performed by processors, to determine whether the issues are addressed or resolved by communicating with the customer. If not, the neural networks may generate instructions for the carrier or on-demand delivery service to perform to address or resolve the issues related to the scheduled delivery. Alternatively, neural networks, performed by one or more processors, may determine that the issues cannot be addressed or resolved without the customer and the carrier engaging in a conversation through a phone call. The system may initiate a phone call such that they can have a conversation. For instance, the system identifies that the delivery driver is nearing a gated community, but the entry code provided is incorrect, or there are unexpected road closures en route due to construction work. In such cases, the system may prompt the carrier to directly contact the customer to clarify the situation, seek an alternative entry method, or rearrange the delivery details when automated solutions or pre-set instructions are insufficient or inapplicable.

The system may receive feedback, a response, or other communication from the carrier and the customer whether the contact resolved or addressed the issues related to the scheduled delivery. For instance, a customer and/or carrier may use an emoji, such as a thumbs-up or thumbs-down, or leave a written comment detailing their experience. They can mention that the courier placed the parcel outside where it was exposed to rain, resulting in damage. As a suggestion for future deliveries, the customer and/or carrier may recommend leaving packages under a sheltered area or within a designated safe spot to prevent similar issues. The system may use the feedback to fine-tune various neural networks that were used to generate chat triggers, generate contents after initiating the contact, and determine whether the issues were addressed or updated. The system may use hardware accelerators and model compression techniques to fine-tune the neural networks. The neural networks can include, without limitation, convolutional neural network, feedforward neural network, recurrent neural network, long short term memory, generative adversarial network (GAN), autoencoder, transformer neural network, etc.

Also, the system can use feedback to modify specific sections of the profile settings for both the customer and the carrier. For instance, certain settings might remain at their default values if the customer or carrier has not provided specific information. These default settings are subject to adjustment based on the feedback received, allowing for a more personalized and optimized experience in future interactions.

By using neural networks performed by processors, the system may reduce (e.g., minimize) or even avoid having the customer and carrier directly converse with each other when an issue arises out of a scheduled delivery. The neural networks may identify when to generate a chat trigger, generate contents for the contact, and identify any instructions that may solve or address the issues.

In the preceding and following description, various techniques are described. For purposes of explanation, specific configurations and details are set forth in order to provide a thorough understanding of ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) simplified interface to establish contact between customers and transporters, (2) efficient usage of computing resources (e.g., processing power, memory requirements, network bandwidth) by handling complex contacts accurately and on time.

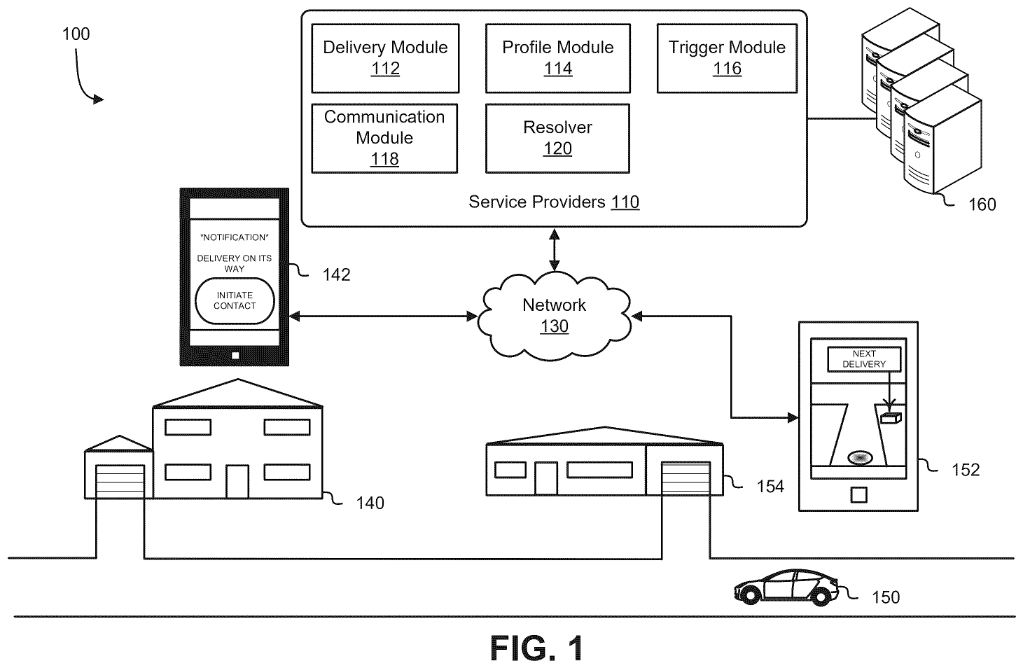

FIG. 1 illustrates a schematic diagram including an example system 100 that establishes contact between carriers and customers using neural networks, according to at least one embodiment. System 100 may include service providers 110, network 130, computing devices 160, customer client device 142, and carrier client device 152.

In at least one embodiment, service providers 110 can be one or more entities that offer an integrated suite of services encompassing delivery, retail, and computing resource functionalities. Service providers 110 may facilitate execution of e-commerce transactions, logistics management, and digital services deployment. The delivery service provided by service providers 110 may include leveraging an optimized network of logistics and distribution channels. Retail services provided by service providers 110 can include online marketplace platforms, point-of-sale systems, and customer relationship management tools, all aimed at enhancing the consumer shopping experience and streamlining merchant operations.

The computing resources component of the service providers 110 may support the aforementioned delivery and retail services. This may include cloud-based storage solutions, computational power for data processing, and hosting environments for e-commerce platforms. These resources may enable service providers 110 to process vast amounts of data, support complex retail and delivery operations, and offer scalable solutions. Additionally, service providers 110 may integrate software as a service (SaaS) platforms into existing operations of service providers, enabling for real-time data exchange, automation of key processes, and improved decision-making capabilities.

For example, various SaaS platforms of service providers 110 may use logistics and routing algorithms to optimize delivery routes, thereby enhancing the efficiency and reliability of on-demand delivery services. The platforms may provide inventory management and forecasting tools, enabling retail service providers to maintain optimal stock levels and reduce waste. In addition, service providers 110 can integrate different types of services (e.g., on-demand delivery service, retail service, database service, block-level data storage service, virtual computer system service, archival data storage service, on-demand data storage service, etc.).

In at least one embodiment, computing devices 160 form an infrastructure (e.g., system 100) to enable service providers 110 to deliver a wide range of services, catering to the needs of various customers and industries. For example, computing devices 160 provide hardware and software herein to service providers 110 to meet the diverse needs of hosting, managing, and delivering services to end-users. Computing devices 160 may include, servers, storage devices (e.g., high-capacity hard drives, solid-state drives (SSD), storage area networks (SANs)), network devices (e.g., routers, switches, firewalls, load balancers), data center infrastructure (e.g., cooling systems, power supply units, backup generators), edge devices, cloud infrastructure (e.g., virtual machines, containers), security appliances (e.g., hardware security modules (HSMs), intrusion detection systems (IDS), intrusion prevention systems (IPS)), management and monitoring tools, etc. Management and monitoring tools may refer to devices or software tools designed for network and system monitoring, configuration management, and performance analysis that help service providers maintain optimal service levels, predict potential issues, and manage resources efficiently.

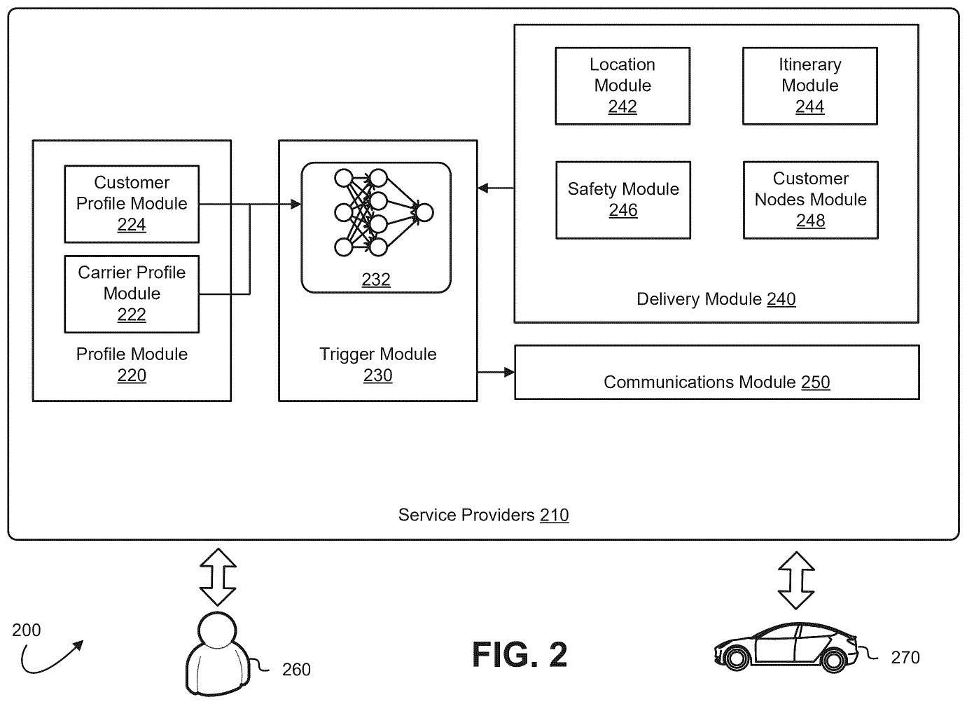

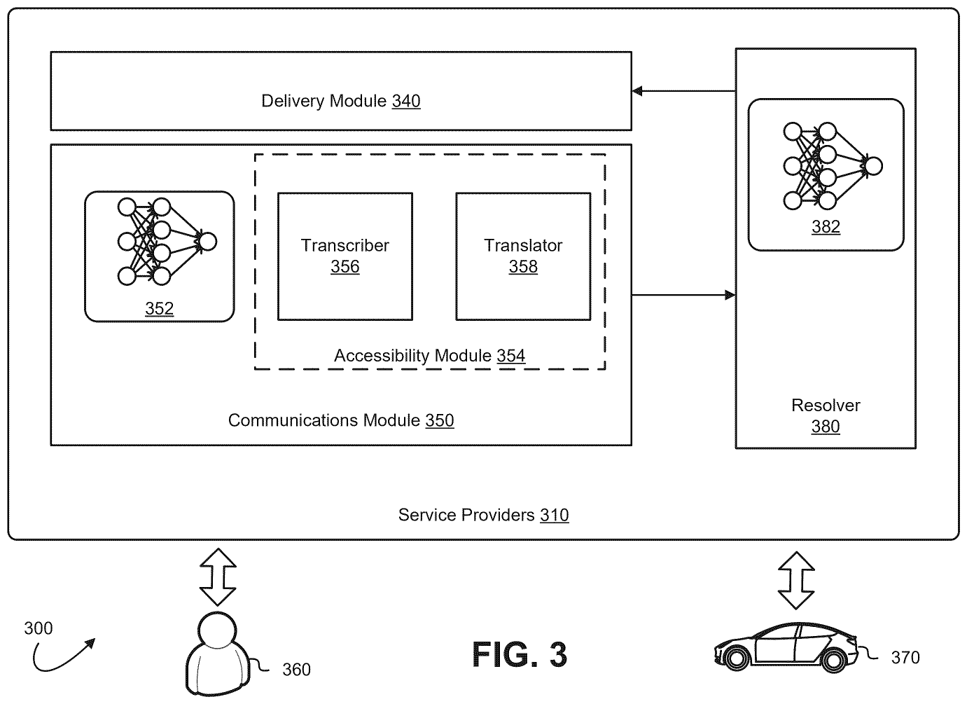

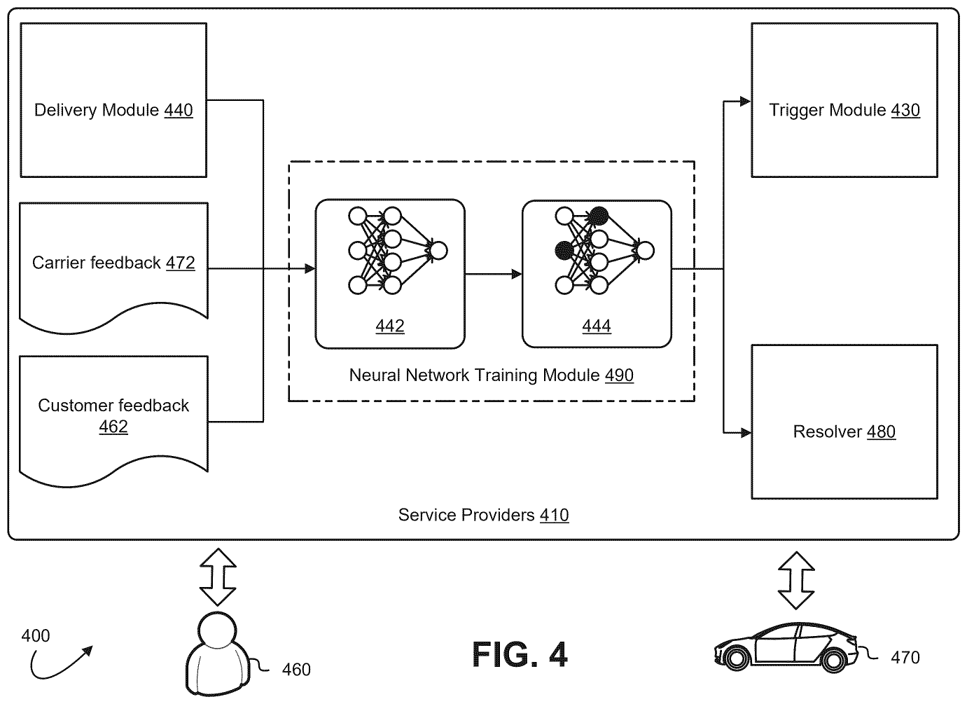

In at least one embodiment, service providers 110 may include delivery module 112, profile module 114, trigger module 116, communications module 118, and resolver 120. In various examples, as used in any implementation described herein, unless otherwise clear from context or stated explicitly to the contrary, terms such as “module” and nominalized verbs (e.g., delivery module 112, profile module 114, trigger module 116, communications module 118, resolver 120, profile module 220, trigger module 230, delivery module 240, communications module 250, delivery module 340, communications module 350, resolver 380, delivery module 440, trigger module 430, resolver 480, delivery module 112, delivery module 502, profile module 504, trigger module 506, communications module 508, resolver 510, etc.) illustrated throughout FIGS. 1-5 each refers to any combination of software logic, hardware logic, and/or circuitry configured to provide specific functionality within the broader service infrastructure (e.g., service providers 110, service providers 210 illustrated in FIG. 2, service providers 310 illustrated in FIG. 3, service providers 410 illustrated in FIG. 4). Module may correspond to various services (e.g., on-demand delivery service, retail service, SaaS provided by the broader service infrastructure).

Terms such as “hardware” described herein may include one or more of central processing units (CPUs), hardwired circuitry, programmable circuitry, state machine circuitry, fixed function circuitry, execution unit circuitry, firmware that stores instructions executed by programmable circuitry, integrated circuit (IC), system on-chip (SoC), graphics processing unit (GPU), data processing unit (DPU), digital signal processor (DSP), tensor processing unit (TPU), accelerated processing unit (APU), application-specific integrated circuits (ASIC), intelligent processing unit (IPU), neural processing unit (NPU), smart network interface controller (SmartNIC), vision processing unit (VPU), field-programmable gate array (FPGA), etc.

In addition, terms such as “software” described herein may include one or more of operating systems, device drivers, application software, database software, graphics software (e.g., Radeon, Intel Graphics), web browsers, development software (e.g., integrated development environments, code editors, compliers, interpreters), network software (e.g., intel PROset, Intel Advanced Network Services), simulation software, real-time operating systems (RTOS), artificial intelligence software (e.g., Scikit-learn, TensorFlow, PyTorch, Accord.NET, Apache Machout), robotics software (Robotics Benchmarks for Learning (ROBEL), MS AirSi, Apollo Baidu, ROSbot 2.0, Poppy Project), firmware (e.g., BIOS/UEFI, router, smartphone, consumer electronics, embedded systems, printer, solid state drive (SSD)), application programming interface (API), containerized software (e.g., Nginx, Apache HTTP Server, MySQL, PostgreSQL, Redis, Memcached, Node.js, Elasticsearch, Gitlab, Jenkins, WordPress), container orchestration platform (e.g., Kubernetes, Docker Swarm, Apache Mesos, Nomad, Microsoft Azure Kubernetes Service, Google Kubernetes Engine, Red Hat OpenShift, Rancher) and any other implementation embodied as a software package, code and/or instruction set.

In at least one embodiment, delivery module 112 can be a module that corresponds to an on-demand delivery service that connects individuals who wish to deliver packages with those who need items delivered, creating a flexible workforce that can adapt to varying demands. Delivery module 112 may facilitate immediate or scheduled delivery of goods and services to customers upon request.

In various examples, execution of scheduled delivery may include a process that begins when a customer places an order and opts for a scheduled delivery, selecting a preferred date and time window for the arrival of their package. Delivery module 112 may map out the most efficient delivery route and assign the task to an available carrier. Delivery module 112 may ensure, via combination of hardware and software, that the package is prepared, dispatched, and delivered within the agreed-upon period, all while keeping the customer informed with real-time updates. Delivery module 112 may use cloud computing to dynamically adjust schedule based on real-time traffic conditions, carrier availability, and customer preferences.

In one example, there can be a customer who orders a custom-made piece of jewelry intended as a gift, with a specific delivery date to coincide with a special occasion. Delivery module 112 may analyze the production time, locates the nearest carrier with the optimal route to the customer's address, and schedules the pickup from the jeweler immediately upon completion. Throughout this process, delivery module 112 may continuously update the estimated delivery time, considering several factors such as traffic, weather conditions, and the carrier's current load.

Delivery module 112 may manage multiple stations by allocating orders based on various criteria such as geographic proximity, station capacity, and specialization in certain types of orders. Stations can be a physical location or hub where delivery operations are coordinated and changed. Stations may include, for example, local distribution center, pick-up point (e.g., warehouse, retail store), vehicle depot, sorting facility, customer service center, etc.

Delivery module 112 may ensure that orders are directed to the most suitable station, facilitating optimal resource utilization and timely order fulfillment. Delivery module 112 may analyze real-time data to predict demand surges, allowing the service to dynamically adjust its operations, such as redistributing resources or prioritizing orders, to maintain efficiency. Moreover, delivery module 112 may facilitate communication between stations (not illustrated in FIG. 1), delivery personnel, and customers.

Delivery module 112 may, via application installed on client devices, guide the carriers to perform steps to complete a delivery route. Specifically, delivery module 112 may display instructions associated with a current delivery step for the carriers to guide the completion of each delivery step. The instructions may include directing the carriers to drive from one location to another. It may further include instructions to drive to a starting location to receive further instructions. For example, delivery module 122 may send information associated with a scheduled delivery via network 130 to carrier client device 152. In one example, carrier client device 152 displays map data of the next scheduled delivery.

Network 130 may include routers, switches, and modems that facilitate internet connectivity by direct data traffic efficiently across network 130. Also, network 130 may include cell towers and base stations that enable carrier's and recipient's client devices to connect to the internet and the service providers 110 via Fourth Generation (4G), Fifth Generation (5G) networks or other networks supported by Generation Partnership Project (3GPP). Virtually, network 130 can use computing technologies, providing a scalable and reliable platform for hosting applications and databases of service providers 110. Network 130 may include servers hosted in data centers that run the software necessary for order management, routing algorithms, and communication protocols. Network 130 may include application programming interfaces (APIs) to facilitate interactions between different software components, such as the application for carriers, customer ordering platforms, and backend systems of service providers 110.

Delivery module 112 may receive shipment data associated with orders and process the orders for station 102. The shipment data may include data for a shipment that may be processed into orders to be delivered from station 102. In some examples, delivery module 112 may receive and process the shipment data ahead of receiving shipment to schedule offers for time slots. Delivery module 112 may generate optimized routes by grouping orders based on delivery areas. Delivery module 112 may determine an estimated delivery time and limit the optimized routes to a maximum delivery block time. The maximum delivery block time can be any reasonable length of work time (e.g., two hours total, three hours total, etc.). Delivery module 112 may determine a schedule for each delivery route, including an approximate start time and end time, and generate time slots based on the delivery routes. Delivery module 112 may generate time slots with scheduled deliveries to include a starting location (e.g., address for a station to pick up packages or items), an expected start time, an expected total delivery time to complete the time slot, and payment for the time slot. Delivery module 112 may determine the capacity of station and determine to stagger the start time for the blocks to avoid too many carriers arriving at the same time.

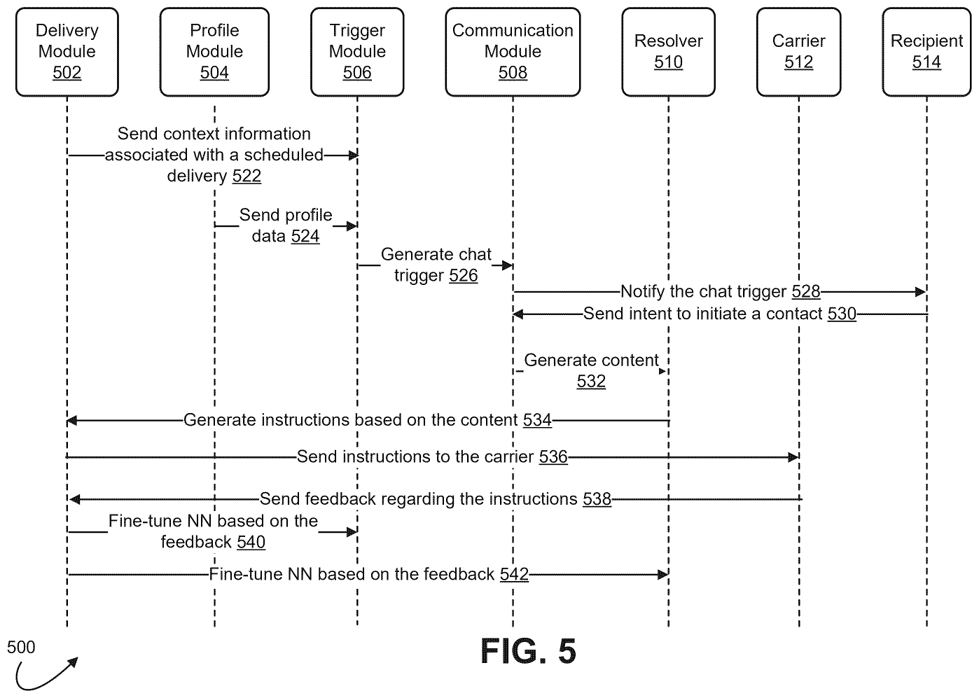

In various examples, delivery module 112 may provide context information that is to be described further herein. Context information may include any information that is specific to a scheduled delivery (e.g., traffic, weather, customer notes regarding the delivery). Delivery module 112 may include delivery module 240 illustrated in FIG. 2, delivery module 340 illustrated in FIG. 3, delivery module 440 illustrated in FIG. 4, and/or delivery module 502 illustrated in FIG. 5.

In at least one embodiment, trigger module 116 can be a module that determines when to generate a chat trigger for a scheduled delivery using one or more neural networks performed by one or more processors (e.g., central processing unit (GPU), GPU, or any other hardware accelerators). Trigger module 116 may use one or more neural networks that uses the context information provided by delivery module 112, profile data of both customer and carrier associated with a scheduled delivery from the profile module 114 to determine whether a chat trigger should be sent to the customer via communications module 250. Trigger module 116 may determine types of a communication medium to send the chat trigger based on those inputs. The types can include for example, phone calls, email, instant messaging, video calls, social medial messaging, short message service (SMS), multimedia messaging service (MMS), voicemail, etc. The chat triggers may include, order confirmation, delivery reminder, real-time delivery updates, feedback requests, address confirmation, instructions request, security code or access information, or any other events or issues that can be related to a scheduled delivery.

Trigger module 116 may update (e.g., fine-tune) the one or more neural networks or use other modules such as neural network training module 490 illustrated in FIG. 4 to update the one or more neural networks based on customer feedback and carrier feedback further described herein. Trigger module 116 may include trigger module 230 illustrated in FIG. 2, trigger module 430 illustrated in FIG. 4, and/or trigger module 506 illustrated in FIG. 5.

In at least one embodiment, profile module 114 can be a module that stores and manages settings that are specific to customers and carriers. Profile module 114 may include a database that stores profile settings of customers and profile settings of carriers. Profile settings of customers and profile settings of carriers can be generated by different services (e.g., on-demand delivery service, retail service). Different profile settings are further described herein. Profile module 114 may include profile module 220 illustrated in FIG. 2 and/or profile module 504 illustrated in FIG. 5.

In at least one embodiment, communications module 118 can be a module that facilitates communication between service providers 110, carriers (e.g., carrier 150), and customers. Communications module 118 may orchestrate digital communication methods, including but not limited to, phone calls, text messaging, as well as WhatsApp and Facebook messages, alongside the capability to dispatch notifications via applications. Communications module 118 may integrate diverse communication protocols and Application Programming Interfaces (APIs) to furnish users (e.g., customers, carrier) with a unified interface for the initiation, reception, and administration of communications across distinct platforms.

Communications module 118 may receive chat triggers from trigger module 116 and communicate that to client device of customer 142 via network 130. One example would be ‘notification, delivery on its way’ and a button to press ‘initiate contact’ as displayed in the client device of customer 142. After receiving a response from the client device of customer 142, communications module 118 may initiate a contact between client device of customer 142 and client device of customer 152. Modality of the contact (e.g., WhatsApp, Facebook, virtual chat assistant, etc.) may depend on the chat trigger received by trigger module 116.

In various examples, communications module 118 may generate, using one or more neural networks performed by one or more processors (e.g., central processing unit (GPU), GPU, or any other hardware accelerators), content to be communicated via the contact. One example can be translating what was sent from client device of customer 142 to a language based on language preferences of carrier 152 noted in profile module 114. Another example can be transcribing audio data sent from client device of customer 142. Also, the one or more neural networks may generate images based on prompts that were received from client device of customer 142 via network 130. Communications module 118 may generate a chatbot that interacts with client device of customer 142 using the one or more neural networks. For each functionality, communications module 118 may train, deploy and fine-tune separate neural networks. Contents generated by those neural networks may indicate one or more issues associated with a scheduled delivery. Communications module 118 may include communications module 250 illustrated in FIG. 2, communications module 350 illustrated in FIG. 3, and/or communications module 508 illustrated in FIG. 5.

In at least one embodiment, resolver 120 can be a module that generates instructions for carriers (e.g., carrier 150) to resolve or address issues associated with scheduled deliveries. In various examples, issues may refer to any kind of problems that arise out of a scheduled delivery to be executed. For example, issues may include inadequate communication between the on-demand delivery service, problems with the on-demand delivery service's tracking system or internal software, address accessibility (e.g., restricted access, security measures, remote locations), problems with pets, problems with languages, recipient not being available at the time of delivery, theft or security issues, delivery delays due to weather conditions, logistical challenges, traffic, incorrect or incomplete address, or any other events that become a problem for a carrier to complete the scheduled delivery.

Resolver 120 may receive from communication module 118 contents and any other information that was exchanged between communications module 118 and client device of customer 142. Resolver 120 may use one or more neural networks performed by one or more processors (e.g., central processing unit (GPU), GPU, or any other hardware accelerators) to determine whether the one or more issues have been resolved. If the one or more issues have been resolved, resolver 120 may indicate to the delivery module 112 that it is good to notify client device of carrier 152 to proceed with the scheduled delivery. If the one or more issues have been unresolved, resolver 120 may use the one or more neural networks to generate one or more instructions to resolve the one or more issues. Resolver 120 may send the one or more instructions to the delivery module 112 such that those instructions can be either performed by the delivery module 112 or indicated to client device of carrier 152 such that one or more instructions can be performed by carrier 150. Resolver 120 may include resolver 280 illustrated in FIG. 3, resolver 480 illustrated in FIG. 4, and/or resolver 510 illustrated in FIG. 5.

Service providers 110 may use one or more modules (e.g., delivery module 112, profile module 114, trigger module 116, communication module 118, resolver 120) to determine that a contact is necessary to resolve the one or more issues prior to or during an execution of a delivery. For example, when carrier 150 arrives at a previous delivery location 154, delivery module 112 may receive context information that the carrier is arriving at the address of the scheduled delivery 140 soon. Delivery module 112 sends the context information to the trigger module 116 such that the module generates and sends chat triggers to communication module 118. Communication module 118 notifies the chat triggers via network 130 to client device of customer 142. That way, a contact can be initiated, and the issues raised can be solved without carrier 150 and customer directly having a conversation.

FIG. 2 illustrates a block diagram including an example system 200 that generates trigger events to establish contact between carriers and customers using neural networks, according to at least one embodiment. System 200 may include service providers 210, customer 260, and carrier 270. Service providers 210 can be one or more entities that offer an integrated suite of services encompassing delivery, retail, and computing resource functionalities. Service providers 210 may include service providers 310 illustrated in FIG. 3 and/or service providers 410 illustrated in FIG. 4. Service providers 210 may include profile module 220, trigger module 230, delivery module 240, and communications module 250.

In at least one embodiment, profile module 220 can be a module that stores and manages settings that are specific to customers and carriers. Profile module may include carrier profile module 222 and customer profile module 224. Carrier profile module 222 can be a module that stores and manages data that are specific to carriers of an on-demand delivery service provided by service providers 210. Carrier profile module 222 may gather, store, and process carrier-related information such as personal identification details, contact information, vehicle specifications (including model, make, and capacity), delivery history, performance metrics, and availability schedules. Additionally, carrier profile module 222 may process delivery preferences (e.g., routes for delivery, avoiding dogs), types of goods willing to transport, and any special certifications (e.g., for handling hazardous materials). Carrier profile module 220 may generate default data that are not defined by customers. Those default data are subject to being updated after receiving customer or carrier feedback.

Also, carrier profile module 220 may include a data redaction feature, designed to identify and anonymize sensitive customer information in compliance with local privacy regulations and standards. This feature may scan customer profiles and transaction records, redacting personally identifiable information (PII) and other sensitive data as mandated by jurisdiction-specific privacy laws such as GDPR in Europe or CCPA in California. This ensures that the retail service adheres to legal requirements for data protection and privacy, safeguarding customer information.

Customer profile module 224 can be a module that stores and manages data that are specific to customers of retail service provided by service providers 210. Customer profile module 224 may compile, store, and process customer-related information. Customer profile module 224 may aggregate personal details, purchase history, preferences, and interaction logs with the retail service. Customer profile module 224 may store desired delivery parameters, such as preferred delivery times, locations, and methods (e.g., in-store pickup, home delivery, curbside pickup). Customer profile module 224 may also include preferences for communication regarding delivery status, such as SMS updates, email notifications, or app-based alerts (e.g., WhatsApp, Facebook, Instagram). Carrier profile module 220 may also include language preferences. Carrier profile module 220 may generate default data that are not defined by customers. Those default data is subject to being updated after receiving customer or carrier feedback.

Also, customer profile module 224 may include a data redaction feature, designed to identify and anonymize sensitive customer information in compliance with local privacy regulations and standards. This feature may scan customer profiles and transaction records, redacting personally identifiable information (PII) and other sensitive data as mandated by jurisdiction-specific privacy laws such as GDPR in Europe or CCPA in California. This may ensure that service providers 210 adhere to legal requirements for data protection and privacy. Profile module can send data from customer profile module 224 and carrier profile module 224 to trigger module 230. Profile module 220 may include profile module 504 illustrated in FIG. 5.

In at least one embodiment, delivery module 240 can be a module that corresponds to an on-demand delivery service that connects individuals who wish to deliver packages with those who need items delivered, creating a flexible workforce that can adapt to varying demands. Delivery module 240 may include location module 242, itinerary module 244, safety module 246, and customer notes module 248.

Location module 242 can be a module that processes location data of carriers (e.g., carrier 270) engaged in executing scheduled deliveries within a logistics and delivery service. Location module 242 may collect, analyze, and manage real-time geospatial information from a network of carriers to optimize delivery routes, enhance operational efficiency, and improve overall service reliability. Location module 242 may integrate with GPS and other location-tracking technologies present in carriers' devices, enabling the continuous acquisition of precise location data.

Itinerary module 244 can be a module that determines delivery routes for carriers. Itinerary module 244 may facilitate real-time tracking of carriers' movements, calculating estimated times of arrival (ETAs) for scheduled deliveries, and dynamically adjusting delivery routes in response to traffic conditions, road closures, or other unforeseen logistical challenges communicated by safety module 246 and location module 242. Itinerary module 244 may perform and leverage historical location data and delivery patterns to forecast potential disruptions and proactively suggest route alterations or schedule adjustments.

Safety module 246 can be a module for reception and management of safety issues. Safety module 246 may monitor environmental and logistical factors that may pose risks to the safety of the delivery process by harnessing data from traffic monitoring systems, weather forecasting services, and carrier-reported incidents. Safety module 246 may identify potential safety hazards such as heavy traffic, accidents, extreme weather conditions, and unsafe roadways that could impede the delivery process or endanger the carrier. Upon detecting these safety issues, the module may generate alerts and provide recommendations for alternative actions. This could involve suggesting safer routes, adjusting delivery schedules to avoid high-risk times or conditions, or even temporarily halting deliveries in extreme cases to ensure carrier safety.

Customer notes module 248 can be a module that manages notes from recipients of a scheduled delivery. Recipients may submit specific instructions, preferences, or requests related to their impending delivery, such as preferred drop-off locations, handling instructions for sensitive items, or scheduling preferences. Customer notes module 248 may categorize, store, and relay these notes to the relevant parties (e.g., carrier 270) involved in the delivery process.

In various examples, delivery module 240 may generate context information by extracting different types of data from location module 242, itinerary module 244, safety module 246, and customer notes module 248 in response to a request for context information associated with a scheduled delivery. Delivery module 240 may send context information associated with a scheduled delivery from various modules (e.g., location module 242, itinerary module 244, safety module 246, customer notes module 248) to trigger module 230. Delivery module 240 may include delivery module 340 illustrated in FIG. 3, delivery module 440 illustrated in FIG. 4, and/or delivery module 502 illustrated in FIG. 5.

In at least one embodiment, trigger module 230 can be a module that identifies when to initiate a contact for the scheduled delivery using one or more neural networks. Trigger module 230 may use one or more neural networks 232, performed by one or more processors (e.g., central processing unit (CPU), GPU, or any other hardware accelerators), that uses the context information provided by delivery module 240, profile data of both customer 260 and carrier 270 associated with a scheduled delivery from profile module 220 to determine whether a chat trigger should be sent to the customer via communications module 250. Trigger module 230 may determine modality of the chat trigger (e.g., chat, phone call, smart watch) based on those inputs. One or more neural networks 232 may include, convolutional neural network, feedforward neural network, recurrent neural network, long short term memory, generative adversarial network, autoencoder, transformer neural network, etc. Trigger module 230 may update (e.g., fine-tune) one or more neural networks 232 or use other modules such as neural network training module 490 illustrated in FIG. 4 to update the one or more neural networks based on customer feedback and carrier feedback further described herein. Trigger module 230 may include trigger module 430 illustrated in FIG. 4, and/or trigger module illustrated in FIG. 5.

In at least one embodiment, communications module 250 can be a module that facilitates communication between service providers 210, carriers (e.g., carrier 270), and customers (e.g., customer 260). Communications module 250 receives the chat triggers from trigger module 230 such that the chat triggers can be communicated to customer 260. Communications module 250 may include communications module 350 illustrated in FIG. 3, and/or communications module 508 illustrated in FIG. 5.

FIG. 3 illustrates a block diagram including an example system 300 that generates contents and instructions after establishing contact between carriers and customers using neural networks, according to at least one embodiment. System 300 may include service providers 310, customer 360, and carrier 370. Service providers 310 can be one or more entities that offer an integrated suite of services encompassing delivery, retail, and computing resource functionalities. Service providers 310 may include service providers 410 illustrated in FIG. 4. Service providers 310 may include delivery module 340, communications module 350, and resolver 380.

In at least one embodiment, delivery module 340 can be a module that corresponds to an on-demand delivery service that connects individuals who wish to deliver packages with those who need items delivered, creating a flexible workforce that can adapt to varying demands.

Delivery module 340 may include delivery module 440 illustrated in FIG. 4, and/or delivery module 502 illustrated in FIG. 5.

In at least one embodiment, communications module 350 can be a module that facilitates communication between service providers 310, carriers (e.g., carrier 370), and customers (e.g., customer 360). Communications module 350 may send chat triggers generated by, for example, trigger module 230 illustrated in FIG. 2 to customer 360. As a result, customer 360 may send an intent to initiate a contact. Communications module 350 may initiate the contact and may generate a virtual chat assistant to communicate with customer 360. Communications module 350 may use one or more neural networks 352, performed by one or more processors (e.g., central processing unit (GPU), GPU, or any other hardware accelerators), to generate the virtual chat. To support the conversation, communications module 350 may use one or more neural networks 352 to content (such as text, images, or videos) for transmission through the initiated contact. Contents may indicate one or more issues associated with a scheduled delivery. One or more neural networks 352 may include, convolutional neural network, feedforward neural network, recurrent neural network, long short term memory, generative adversarial network, autoencoder, transformer neural network, etc. Communications module 350 may use one or more neural networks 352 to perform various natural language processing (NLP) and computer vision tasks to assist the contact.

Communications module 350 may utilize accessibility module 354 that includes a transcriber 356 and translator 358 to provide different functionality. For example, transcriber 356 may use separate neural networks, performed by one or more processors (e.g., central processing unit (GPU), GPU, or any other hardware accelerators), to transcribe audio data received from customer 360 or generated by the one or more neural networks 352. In another example, translator 358 may translate text received by customer 360 to a language based on language preferences of 370 noted in carrier profile module 222 illustrated in FIG. 2. Communications module 350 may send information related to the contact to the resolver 380. Communications module 350 may include communications module 508 illustrated in FIG. 5.

In at least one embodiment, resolver 380 can be a module that generates instructions for carriers (e.g., carrier 370) to resolve or address issues associated with scheduled deliveries. Resolver 380 may receive from communication module 350, contents and any other information that was exchanged between communications module 350 and customer 360. Resolver 380 may use one or more neural networks 382, performed by one or more processors (e.g., central processing unit (GPU), GPU, or any other hardware accelerators), to determine whether the one or more issues have been resolved. If the one or more issues have been resolved, resolver 380 may indicate to the delivery module 340 that it is good to notify client device of carrier 370 to proceed with the scheduled delivery. If the one or more issues have been unresolved, resolver 380 may use one or more neural networks 382 to generate one or more instructions to resolve the one or more issues.

Resolver 380 may send the one or more instructions to the delivery module 340 such that those instructions can be either performed by the delivery module 340 or other modules illustrated in FIG. 2 that are within delivery module 240 or indicated to client device of carrier 370 such that one or more instructions can be performed by carrier 370. One or more neural networks 382 may include convolutional neural network, feedforward neural network, recurrent neural network, long short term memory, generative adversarial network, autoencoder, transformer neural network, etc. Resolver 380 may include resolver 480 illustrated in FIG. 4, and/or resolver 510 illustrated in FIG. 5.

FIG. 4 illustrates a block diagram including an example system 400 that performs neural network training, according to at least one embodiment. System 400 may include service providers 410, customer 460, and carrier 470. Service providers 410 can be one or more entities that offer an integrated suite of services encompassing delivery, retail, and computing resource functionalities. Service providers 410 may include delivery module 440, neural network training module 490, trigger module 430, and resolver 480.

In at least one embodiment, neural network training module 490 is a module to perform neural network training. Neural network training module 490 may receive carrier feedback 472, customer feedback 462 and other information associated with one or more scheduled deliveries from delivery module 440. Delivery module 440 can be a module that corresponds to an on-demand delivery service that connects individuals who wish to deliver packages with those who need items delivered, creating a flexible workforce that can adapt to varying demands. Delivery module 440 may include delivery module 502 illustrated in FIG. 5.

In various examples, carrier feedback 472 may include how clear and understandable the delivery instructions are, accuracy of the delivery details provided, how promptly carrier 470 receive updates or changes to delivery instructions, practicality of the instructions given, how instructions are presented (e.g., visual aids), concerns about instructions that put them in unsafe situations, efficiency, etc.

In some examples, customer feedback 462 may include clarity, frequency, and usefulness of the contact regarding the delivery, effectiveness in resolving the one or more issues associated with the scheduled delivery, how well their delivery instructions (as sent to delivery module 440) were followed, tailored delivery options or personalized communication, etc.

Neural network training module 490 may use carrier feedback 472, customer feedback 462, and other information to train neural networks 442 to generate updated neural networks 444. Prior to performing neural network training, neural network training module 490 may redact data with privacy concerns to comply with local privacy regulations (e.g., General Data Protection Regulation (GDPR)). Neural networks 442 can be untrained neural networks, partially trained neural networks, or fully trained neural networks. Updated neural networks 444 can be partially trained neural networks, fully trained neural networks, or fine-tuned neural networks. Particularly, updated neural networks 444 may include fine-tuned neural networks that perform various functions for service providers 410, such as, for example, generating chat triggers, generate contents to be communicated via a contact between customer 460 and carrier 470, generate instructions for carrier 470, language translation, image generation, audio transcription, and any other natural language processing (NLP) and/or computer vision.

In various examples, neural networks 442 and/or updated neural networks 444 may include convolutional neural network, feedforward neural network, recurrent neural network, long short term memory, generative adversarial network, autoencoder, transformer neural network, etc.

Neural network training module 490 may perform neural network training by performing one or more of supervised training, unsupervised learning, semi-supervised learning, reinforcement learning, self-supervised learning, transferred learning, etc. Neural network training module 490 may determine hyperparameters to train the neural networks. The hyperparameters may include learning rate, batch size, number of epochs, number of layers, number of neurons, activation function, loss function, optimization algorithm, regularization technique, initialization method, momentum, etc. Score generation module 230 may initialize weights of the one or more neural networks by performing one or more of zero or constant initialization, random initialization, Xavier initialization, He initialization, LeCun initialization, orthogonal initialization, sparse initialization, etc.

Neural network training module 490 may use software stacks and libraries to fine-tune neural networks, where software stacks and libraries can compress the neural networks during fine-tuning. Additionally, neural network training module 490 may use one or more hardware accelerators (e.g., GPU, FPGA, ASIC) to perform different types of neural network training described herein.

Neural network training module 490 may provide updated neural networks 444 to trigger module 430. Trigger module 430 can be a module that generates a chat trigger for a scheduled delivery using one or more neural networks. Trigger module 430 may include trigger module 506 illustrated in FIG. 5. Trigger module 430 may use updated neural networks 444 to determine when to initiate a contact between carrier 470 and customer 460 of one or more scheduled deliveries, as described further herein.

Neural network training module 490 may provide updated neural networks to resolver 480. Resolver 480 can be a module that generates instructions for carriers (e.g., carrier 470) to resolve or address issues associated with scheduled deliveries. Resolver 480 may include resolver 510 illustrated in FIG. 5. Resolver 480 may use updated neural networks 444 to generate one or more instructions for carrier 470 to perform to resolve or address one or more issues associated with one or more scheduled deliveries, as described further herein. Additionally, Resolver 480 may use updated neural networks 444 to determine whether the one or more issues needs direct communication (e.g., a phone call) between carrier 470 and customer 460, as described further herein.

FIG. 5 illustrates a call-flow diagram 500 in which contacts are managed using neural networks, according to at least one embodiment. In various examples, systems (e.g., service providers 110, service providers 210, service providers 310, service providers 410) include modules such as delivery module 502, profile module 504, trigger module 506, communication module 508, resolver 510, carrier 512, and recipient 514 that can perform one or more steps of call-flow diagram. The modules can be backend services of one or more applications that client devices (of carrier 512 and recipient 514) can have access to.

At step 522, delivery module 502 may send context information associated with a scheduled delivery. The context information may include weather conditions, traffic conditions, notes from recipient 514 regarding the scheduled delivery, safety issues, location of carrier 512, and information of other deliveries that carrier 512 are scheduled to execute.

At step 524, profile module 504 may send profile data, where the profile data can be specific to either carrier 512 or recipient 514 or both. For example, profile data specific to recipient 514 may include building access code, garage access code, language preferences, preferred hours for delivery or any other general preferences related to deliveries. In another example, profile data specific to carrier 512 may include language preferences, type of vehicle, safety concerns (e.g., dog barking), or any other information of carrier 512 that are not specific to a particular delivery but still usable to generate chat triggers.

At step 526, trigger module 506 may generate, using one or more first neural networks performed by one or more processors (e.g., graphics processing unit (GPU)), chat trigger. At step 528, trigger module 506 may send the chat trigger to communication module 508 such that communication module 508 may notify the chat trigger to the recipient. Chat trigger may indicate that a contact may resolve one or more potential issues associated with the scheduled delivery. At step 530, recipient 514 may send intent to initiate the contact.

At step 532, communication module 508 may generate content that is to be communicated via the contact. For example, communication module 508 may translate what recipient 514 sent to communication module 508 to match language that carrier 512 prefers, which can be indicated in the profile data. In another example, communication module 508 may transcribe voice mails or phone calls directed to communication module 508. Communication module 508 may generate images based on what recipient 514 indicated via the contact. Communication module 508 may use neural networks (e.g., transformer neural networks, GAN) which are performed by one or more processors (e.g., GPU) to generate the content. Then, communication module 508 may send the content to resolver 510.

At step 534, resolver 510 may generate 530, using neural networks performed by one or more processors (e.g., GPU), instructions to cause carrier 512 to resolve or address one or more issues indicated by the content. Instructions may include access codes to buildings or garage or any other information (e.g., image) to assist carrier 512 to complete the scheduled delivery. At step 536, delivery module 502 may send instructions to carrier 512. Delivery module 502 may modify the instructions before sending the instructions to carrier 512.

At step 538, carrier 512 may perform the instructions and send feedback regarding the instructions. The instructions can be effective to complete the scheduled delivery. On the other hand, the instructions can be ineffective to complete the scheduled delivery. At step 540, delivery module 502 may utilize one or more processors (e.g., GPU) to fine-tune 536 neural networks that are to be deployed by profile module 504 (e.g., ones that are used to generate chat triggers) based on carrier 512 feedback. Recipient 514 feedback can also be used for fine-tuning. At step 540, delivery module 502 may utilize one or more processors (e.g., GPU) to fine-tune neural networks that are to be deployed by profile module 504 (e.g., ones that are used to generate instructions) based on carrier 512 feedback and/or recipient 514 feedback.

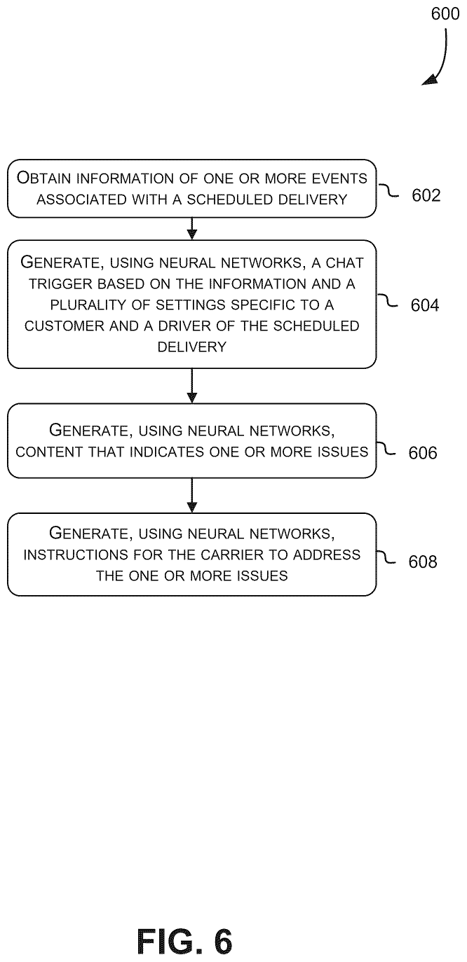

FIG. 6 illustrates an example process 600 to establish contact between carriers and customers using neural networks, according to at least one embodiment. Although process 600 is depicted as a series of steps or operations, it will be appreciated that at least one embodiment of process 600 includes altered or reordered steps or operations, or omits certain steps or operations, except where explicitly noted or logically required, such as when an output of one step or operation is used as input for another.

One or more entities described in conjunction with FIGS. 1-5, singly or in any combination, may perform each block of process 600. For example, the one or more entities may include at least one component of system 100, system 200, example 300, example 400 and/or example 500 illustrated in FIGS. 1-5. For example, the one or more entities may include delivery module 112, profile module 114, trigger module 116, communication module 118, and resolver 120 illustrated in FIG. 1. The one or more entities can be backend services of one or more applications to be accessed by mobile devices. The one or more entities may further include, for example, one or more of hardware, firmware, and/or software described in conjunction with FIG. 1.

Various functions can be conducted by a processor executing instructions stored in memory (e.g., computer readable, machine readable) to perform process 600. Also, process 600 may also be implemented as computer-usable instructions (e.g., macro instruction, micro-instruction) stored on computer storage media or provided by a standalone application, a service or hosted service (standalone or in combination with another hosted service).

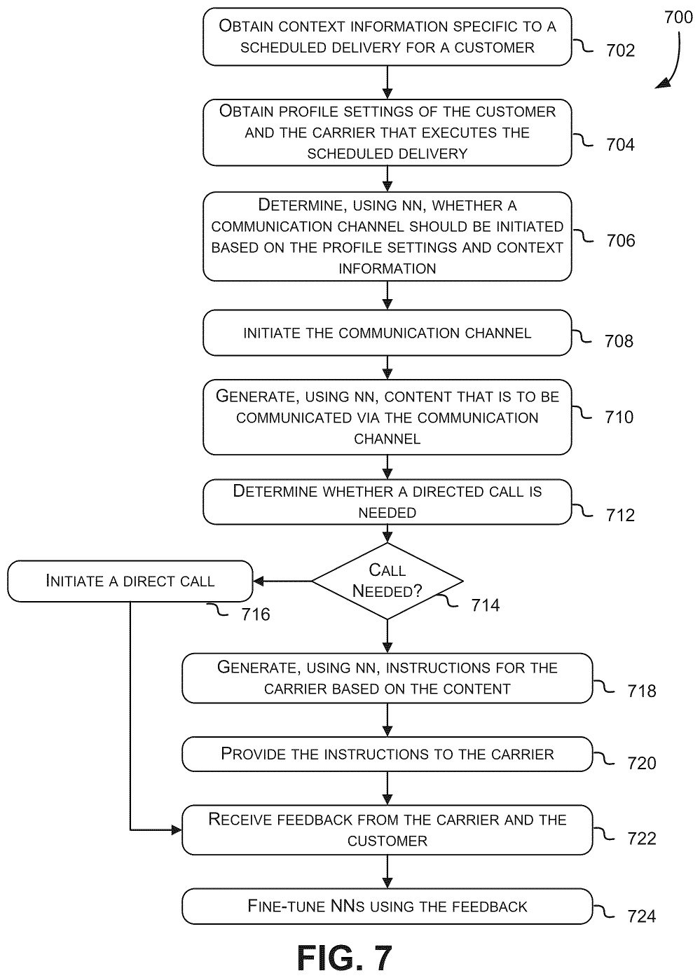

At block 602, the one or more entities may obtain information of one or more events associated with a scheduled delivery. For example, the one or more entities can receive or read the information from a database associated with a on-demand delivery service. In another example, the one or more entities can extract by filtering context information that is only related to the scheduled delivery. The one or more events may include carrier approaching the customer's delivery location, carrier is 2-4 deliveries away from the scheduled delivery, the delivery location is a building, storage, or garage that requires an access code, safety concerns (e.g., construction nearby), etc. In various examples, block 604 may include block 702 and/or block 704 illustrated in FIG. 7.

At block 604, the one or more entities may generate, using neural networks, a chat trigger based on the information and a plurality of settings specific to a customer and a driver of the scheduled delivery. The plurality of settings may include the type of vehicle of the carrier, the customer having a dog inside their premise, etc. The neural networks may include neural networks 232 illustrated in FIG. 2 and/or neural networks 444 illustrated in FIG. 4. The chat trigger is used to initiate a contact between a customer and a carrier regarding a scheduled delivery. In various examples, block 604 may include block 706 illustrated in FIG. 7.

At block 606, the one or more entities may generate, using neural networks, content that indicates one or more issues of the scheduled delivery. The neural networks may include neural networks 352 illustrated in FIG. 3. The content can be generated to exchange information via the contact. The content may indicate one or more issues of the scheduled delivery. The neural networks may generate images, translate what customer sent in different languages, transcribe audio data that customer sent, and perform any other natural language processing (NLP) and/or computer vision tasks to generate the content. In various examples, block 606 may include block 710 illustrated in FIG. 7.

At block 608, the one or more entities may generate, using neural networks, instructions for the carrier to address the one or more issues. The neural networks may include neural networks 382 illustrated in FIG. 3 and/or neural networks 444 illustrated in FIG. 4. The neural networks may use content generated at block 606 to generate the instructions. The one or more entities may modify the instructions before sending those to the carrier. In various examples, block 608 may include block 718 and/or block 720 illustrated in FIG. 7.

In at least one embodiment, the one or more entities may use the neural networks to determine whether the one or more issues have been resolved based, at least in part, on the communication between the carrier, customer, and/or the one or more entities. If the neural networks determine that the one or more issues have been resolved, the one or more entities may send a notification to the carrier and/or the customer that the issues are resolved. If the neural networks determine that the one or more issues have not been resolved, the neural networks may generate the instructions for the carrier as described herein or indicate to the one or more entities that a direct communication (e.g., phone call) between the carrier and customer is required to resolve the one or more issues. In response, the one or more entities may initiate either a voice call or a video call.

FIG. 7 illustrates another example process 700 to initiate contact between carriers and customers using neural networks, according to at least one embodiment. Although process 700 is depicted as a series of steps or operations, it will be appreciated that at least one embodiment of process 700 includes altered or reordered steps or operations, or omits certain steps or operations, except where explicitly noted or logically required, such as when an output of one step or operation is used as input for another.

One or more entities described in conjunction with FIGS. 1-5, singly or in any combination, may perform each block of process 700. For example, the one or more entities may include at least one component of system 100, system 200, example 300, example 400 and/or example 500 illustrated in FIGS. 1-5. For example, the one or more entities may include delivery module 112, profile module 114, trigger module 116, communications module 118, and resolver 120 illustrated in FIG. 1. The one or more entities can be backend services of one or more applications to be accessed by mobile devices. The one or more entities may further include, for example, one or more of hardware, firmware, and/or software described in conjunction with FIG. 1.

Various functions can be performed by a processor executing instructions stored in memory (e.g., computer readable, machine readable) to perform process 700. Also, process 700 may also be implemented as computer-usable instructions (e.g., macro instruction, micro-instruction) stored on computer storage media or provided by a standalone application, a service or hosted service (standalone or in combination with another hosted service).

At block 702, the one or more entities may obtain context information specific to scheduled delivery for a customer. The context information may include weather conditions, traffic conditions, notes from a customer regarding the scheduled delivery, safety issues, location of a carrier, and information of other scheduled deliveries that are executed by the carrier.

At block 704, the one or more entities may obtain profile settings of the customer and carrier that executes the scheduled delivery. For example, the profile settings of the customer may include building access code, garage access code, language preferences, preferred hours for delivery or any other general preferences related to deliveries. In another example, the profile settings of the carrier may include language preferences, type of vehicle, safety concerns (e.g., dog barking), or any other information of the carrier that are not specific to a particular delivery but still usable to generate chat triggers.

At block 706, the one or more entities may determine, using neural networks, whether a communication channel should be initiated based on the profile settings and context information. The determination can be done by identifying or detecting any chat triggers that indicate one or more issues associated with the scheduled delivery. The determination may include selecting modality of the communication (e.g., chat with a virtual agent, chat with the carrier, phone call with the carrier, etc.). The neural networks may include neural networks 232 illustrated in FIG. 2 and/or neural networks 444 illustrated in FIG. 4.

At block 708, the one or more entities may initiate the communication channel. Alternatively, the one or more entities may initiate more than one communication channel. At block 710, the one or more entities may generate, using neural networks, content that is to be communicated via the communication channel (e.g., chat, call, smartwatch). For example, the neural networks may translate what customer sent to the chat assistant to match language that the carrier prefers, which can be indicated in the profile settings.

In another example, the neural networks may transcribe voice mails or phone calls directed to the virtual chatbot. The one or more entities can use the neural networks to generate images based on what customer indicated via the contact. The one or more entities may use various neural networks (e.g., transformer neural networks, GAN) to generate the content. The neural networks may include neural networks 352 illustrated in FIG. 3.

At block 712, the one or more entities may determine whether a directed call is needed. The determination can be based on another determination that the one or more issues cannot be addressed or resolved using the neural networks. At block 714, if the directed call is needed, process 700 may move to block 716 and process 700 may move to block 718 if the directed call is unnecessary. At block 716, the one or more entities may initiate a voice call or video call, where the one or more entities may determine which one based on what was noted in the profile settings. For example, a carrier may prefer to initiate a voice call instead of a video call.

At block 718, the one or more entities may generate, using neural networks, instructions for the carrier based on the content. Instructions may include access codes to buildings or garage or any other information (e.g., image) to assist the carrier to complete the scheduled delivery. The neural networks may include neural networks 382 illustrated in FIG. 3 and/or neural networks 444 illustrated in FIG. 4.

At block 720, the one or more entities may provide the instructions to the carrier. At block 722, the one or more entities may receive feedback from the carrier and the customer. The instructions can be effective to complete the scheduled delivery. On the other hand, the instructions can be ineffective to complete the scheduled delivery. In various examples, if the instructions are ineffective and the issues persist, the one or more entities may initiate a phone call between the customer and the carrier.

At block 724, the one or more entities may fine-tune neural networks using the feedback for customer and/or carrier. Various neural network training techniques such as supervised training, semi-supervised training, unsupervised training, federated learning, etc., can be used to fine-tune the neural networks. The one or more entities may train the neural networks separately based on their respective function (e.g., generate trigger, generate content, generate instructions, etc.).

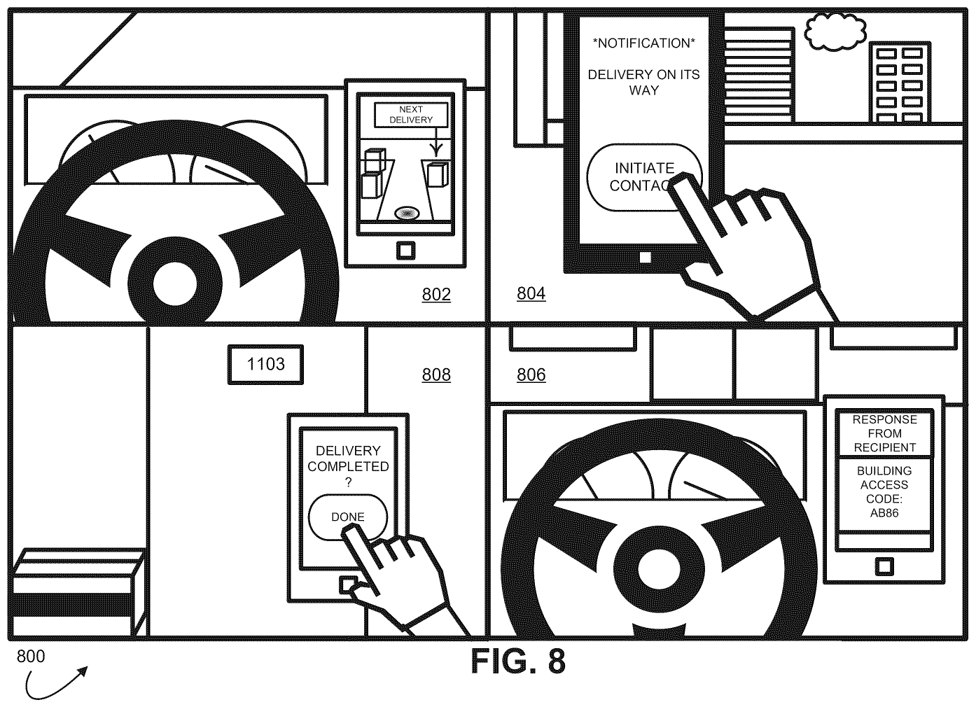

FIG. 8. illustrates an example 800 of executing a scheduled delivery, according to at least one embodiment. First part 802 of example 800 includes a view of a carrier driving his own vehicle to execute one or more scheduled deliveries. The one or more scheduled deliveries can be a portion of a time slot that was offered by an on-demand delivery service. Client device of the carrier may display map information of the next scheduled delivery, where an application of the on-demand delivery service provides the map information.

In at least one embodiment, second part 804 of example 800 includes a view of a customer receiving a notification that indicates a trigger event from an application provided by either a retail service or on-demand delivery service. The trigger event can be generated, using one or more neural networks, based on an indication that the carrier illustrated in first part 802 of example 800 is to execute the next scheduled delivery. The indication can be based on the location of the client device of the carrier. In other examples, the indication can be based on another indication that the previous delivery has been completed. As shown, the customer may interact with the application to send an intention to initiate a communication. Alternatively, the application may initiate the communication without receiving input from the customer.

Additionally, the trigger event can be generated based on profile settings of the customer and the carrier. For example, the profile settings may include that there is a building access code to enter the building where the customer resides. In another example, the profile settings may include that the customer wishes to receive packages at a certain time (e.g., non-work hours). The profile settings may also include preferences of the carrier which is to avoid any animals (e.g., dogs) that may react if the carrier approaches to the delivery address.

In at least one embodiment, third part 806 of process 800 illustrates the carrier receiving instructions to address issues associated with the scheduled delivery. As noted, one of the issues was the carrier not knowing the building access code to enter the building. The one or more neural networks may generate the instructions as a result of the customer pressing the ‘initiate contact’ button displayed in a client device of the customer, as shown in second part 804 of example 800. The one or more neural networks may generate the instructions after the customer exchanges information via the established contact that is not illustrated in example 800. The one or more neural networks may translate what the customer indicated if language preferences of the customer and the carrier are different.

In at least one embodiment, fourth part 808 of process 800 illustrates the carrier successfully executing the scheduled delivery as a result of the one or more neural networks generating a chat trigger, generating any contents to be exchanged via the established contact, and generating any instructions (e.g., providing access code). The client device of the carrier may display ‘delivery completed’ to notify the customer that the package has been sent to the front door. The one or more neural networks may enable the carrier to resolve the issue without having to initiate a direct phone call with the customer.

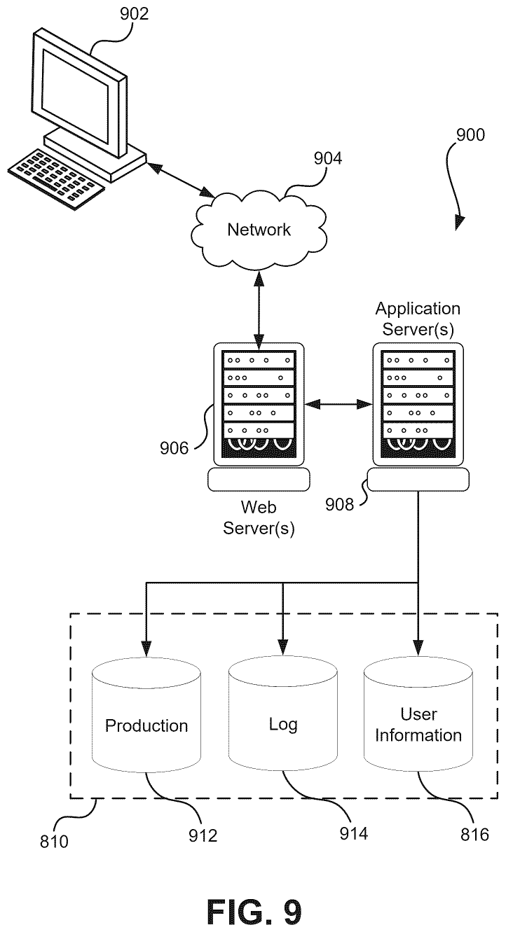

FIG. 9 illustrates aspects of an example system 900 for implementing aspects in accordance with an embodiment. As will be appreciated, although a web-based system is used for purposes of explanation, different systems may be used, as appropriate, to implement various embodiments. In an embodiment, the system includes an electronic client device 902, which includes any appropriate device operable to send and/or receive requests, messages, or information over an appropriate network 904 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 906 for receiving requests and serving content in response thereto, although for other networks an alternative device serving a similar purpose could be used as would be apparent to one of ordinary skill in the art.

In an embodiment, the illustrative system includes at least one application server 908 and a data store 910, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software, and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 902 and the application server 908, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 910, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 912 and user information 916, which are used to serve content for the production side. The data store also is shown to include a mechanism for storing log data 914, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 910.

The data store 910, in an embodiment, is operable, through logic associated therewith, to receive instructions from the application server 908 and obtain, update, or otherwise process data in response thereto, and the application server 908 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 902. Continuing with this example, information for a particular item of interest is viewed in a dedicated page or window of the browser. It should be noted, however, that embodiments of the present disclosure are not necessarily limited to the context of web pages but are more generally applicable to processing requests in general, where the requests are not necessarily requests for content. Example requests include requests to manage and/or interact with computing resources hosted by the system 900 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 900, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 9. Thus, the depiction of the system 900 in FIG. 9 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as JavaR, C, C# or C++, or any scripting language, such as Ruby, PHP, Perl, Python or TCL, as well as combinations thereof. In an embodiment, the one or more servers also include database servers, including without limitation those commercially available from OracleR, Microsoft®, SybaseR, and IBMR as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

The system can be used to implement service providers 110 illustrated in FIG. 1, service providers 210 illustrated in FIG. 2, service providers 310 illustrated in FIG. 3, and/or service providers 410 illustrated in FIG. 4. The system can be used to perform one or more blocks of processes illustrated in FIGS. 5-7. At least one embodiment of the disclosure can be described in view of the following clauses:
1. A computer-implemented method, comprising: obtaining, from a delivery service, an indication that a carrier of a delivery service is to execute a scheduled delivery for a customer of a retail service; obtaining, from a delivery service, context information that indicates one or more events that are specific to the scheduled delivery; obtaining a plurality of carrier settings specific to the carrier and a plurality of customer settings specific to the customer; generating, using one or more first neural networks, a communication medium, between the carrier and the customer based, at least in part, on the plurality of carrier settings, the plurality of customer settings, and the context information; generating, using one or more second neural networks, content to be communicated via the communication medium, wherein the content indicates one or more issues of the scheduled delivery; generating, using one or more third neural networks, one or more instructions for the carrier based, at least in part, on the content, wherein the one or more instructions are for the carrier to address the one or more issues; and providing, to the delivery service, the one or more instructions.
2. The computer-implemented method of clause 1, further comprising: obtaining, from a delivery service, an indication that the one or more issues persist; and generating instructions to initiate a phone call between the customer and the carrier using a mobile device.
3. The computer-implemented method of clause 1 or 2, wherein the communication medium comprises at least one of chat, phone call, video, audio messages, or notification on a user interface.
4 The computer-implemented method of any one of clauses 1-3, further comprising: using a transformer neural network to generate a translation of the content based, at least in part, on language preferences indicated in the plurality of carrier settings.
5. A system, comprising: one or more processors; memory that stores computer-executable instructions that, if executed, cause the one or more processors to: receive context information that is specific to a scheduled delivery to be executed by a carrier; identify, using one or more first neural networks, one or more trigger events associated with the scheduled delivery based, at least in part, on the context information and a plurality of settings particular to the carrier and a recipient of the scheduled delivery; generate a communication channel for the carrier and the recipient based, at least in part, on the one or more trigger events; generate, using one or more second neural networks, content to be communicated via the communication channel, wherein the content indicates an issue associated with the scheduled delivery; generate, using one or more third neural networks, an instruction for the carrier based, at least in part, on the content, wherein the instruction is associated with the issue; and transmit the instruction to the carrier.
6. The system of clause 5, wherein the computer-executable instructions further comprises computer-executable instructions that, if executed by the one or more processors, cause the system to update the one or more third neural networks based, at least in part, on feedback generated by the recipient as a result of transmitting the instruction to the carrier.
7. The system of clause 5 or 6, wherein the computer-executable instructions further comprise computer-executable instructions that, if executed by the one or more processors, cause the system to: receive an indication from the carrier that the issue persists; and initiate a telephone call between the recipient and the carrier.
8 The system of any one of clauses 5-7, wherein the content comprises one or more instructions to the recipient.
9. The system of any one of clauses 5-8, wherein the computer-executable instructions that cause the system to generate the communication channel further include instructions that cause the system to provide a chat interface.
10. The system of any one of clauses 5-9, wherein the context information indicates a location of a device associated with the carrier.
11. The system of any one of clauses 5-10, the computer-executable instructions further comprise computer-executable instructions that, if executed by the one or more processors, cause the system to translate, using a transformer neural network, the content to a language that is indicated in the plurality of settings.
12. The system of any one of clauses 5-11, wherein the one or more second neural networks comprise a transformer neural network.
13. A set of non-transitory computer-readable storage media that stores executable instructions that, if executed by one or more processors of a computer system, cause the computer system to: obtain information associated with a delivery to be executed by a carrier, wherein the information comprises profile settings of the carrier and a recipient of the delivery; generate, using one or more first neural networks, a contact medium between the carrier and the recipient based, at least in part, on the information; generate, using one or more second neural networks, content that is to be communicated via the contact, wherein the content indicates an issue associated with the delivery; identify, using one or more third neural networks, a procedure for the carrier to address the one or more issues indicated by the content; and provide the procedure to the carrier.
14. The set of non-transitory computer-readable storage medium of clause 13, wherein the instructions further comprise instructions that, as a result of being executed by the one or more processors, cause the computer system to update the one or more first neural networks based, at least in part, on feedback generated by the carrier as a result of providing the procedure.
15. The set of non-transitory computer-readable storage medium of clause 13 or 14, wherein the content is a modification of what the recipient sent to indicate the issue.
16. The set of non-transitory computer-readable storage medium of any one of clauses 13-15, wherein the instructions that cause the computer system to generate the contact further include instructions that cause the computer system to provide a chat interface for the recipient and the carrier.
17. The set of non-transitory computer-readable storage medium of any one of clauses 13-16, wherein the one or more third neural networks comprise a transformer neural network.
18. The set of non-transitory computer-readable storage medium of any one of clauses 13-17, wherein the instructions further comprise instructions that, as a result of being executed by the one or more processors, cause the computer system to update the profile settings based, at least in part, on feedback generated by either the carrier or the recipient as a result of providing the procedure to the carrier.
19. The set of non-transitory computer-readable storage medium of any one of clauses 13-18, wherein the information indicates a location of a device associated with the carrier.
20. The set of non-transitory computer-readable storage medium of any one of clauses 13-19, wherein the instructions further comprise instructions that, as a result of being executed by the one or more processors, cause the computer system to translate, using a transformer neural network, the content to a language that is indicated in the profile settings.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
obtaining, from a delivery service, an indication that a carrier of a delivery service is to execute a scheduled delivery for a customer of a retail service;
obtaining, from a delivery service, context information that indicates one or more events that are specific to the scheduled delivery;
obtaining a plurality of carrier settings specific to the carrier and a plurality of customer settings specific to the customer;
generating, using one or more first neural networks, a communication medium, between the carrier and the customer based, at least in part, on the plurality of carrier settings, the plurality of customer settings, and the context information;
generating, using one or more second neural networks, content to be communicated via the communication medium, wherein the content indicates one or more issues of the scheduled delivery;
generating, using one or more third neural networks, one or more instructions for the carrier based, at least in part, on the content, wherein the one or more instructions are for the carrier to address the one or more issues; and
providing, to the delivery service, the one or more instructions.

2. The computer-implemented method of claim 1, further comprising:
obtaining, from a delivery service, an indication that the one or more issues persist; and
generating instructions to initiate a phone call between the customer and the carrier using a mobile device.

3. The computer-implemented method of claim 1, wherein the communication medium comprises at least one of chat, phone call, video, audio messages, or notification on a user interface.

4. The computer-implemented method of claim 1, further comprising:
using a transformer neural network to generate a translation of the content based, at least in part, on language preferences indicated in the plurality of carrier settings.

5. A system, comprising:
one or more processors;
memory that stores computer-executable instructions that, if executed, cause the one or more processors to:
receive context information that is specific to a scheduled delivery to be executed by a carrier;
identify, using one or more first neural networks, one or more trigger events associated with the scheduled delivery based, at least in part, on the context information and a plurality of settings particular to the carrier and a recipient of the scheduled delivery;
generate a communication channel for the carrier and the recipient based, at least in part, on the one or more trigger events;
generate, using one or more second neural networks, content to be communicated via the communication channel, wherein the content indicates an issue associated with the scheduled delivery;
generate, using one or more third neural networks, an instruction for the carrier based, at least in part, on the content, wherein the instruction is associated with the issue; and
transmit the instruction to the carrier.

6. The system of claim 5, wherein the computer-executable instructions further comprises computer-executable instructions that, if executed by the one or more processors, cause the system to update the one or more third neural networks based, at least in part, on feedback generated by the recipient as a result of transmitting the instruction to the carrier.

7. The system of claim 5, wherein the computer-executable instructions further comprise computer-executable instructions that, if executed by the one or more processors, cause the system to:
receive an indication from the carrier that the issue persists; and
initiate a telephone call between the recipient and the carrier.

8. The system of claim 5, wherein the content comprises one or more instructions to the recipient.

9. The system of claim 5, wherein the computer-executable instructions that cause the system to generate the communication channel further include instructions that cause the system to provide a chat interface.

10. The system of claim 5, wherein the context information indicates a location of a device associated with the carrier.

11. The system of claim 5, the computer-executable instructions further comprise computer-executable instructions that, if executed by the one or more processors, cause the system to translate, using a transformer neural network, the content to a language that is indicated in the plurality of settings.

12. The system of claim 5, wherein the one or more second neural networks comprise a transformer neural network.

13. A set of non-transitory computer-readable storage media that stores executable instructions that, if executed by one or more processors of a computer system, cause the computer system to:
obtain information associated with a delivery to be executed by a carrier, wherein the information comprises profile settings of the carrier and a recipient of the delivery;
generate, using one or more first neural networks, a contact medium between the carrier and the recipient based, at least in part, on the information;
generate, using one or more second neural networks, content that is to be communicated via the contact, wherein the content indicates an issue associated with the delivery;
identify, using one or more third neural networks, a procedure for the carrier to address the one or more issues indicated by the content; and
provide the procedure to the carrier.

14. The set of non-transitory computer-readable storage medium of claim 13, wherein the instructions further comprise instructions that, as a result of being executed by the one or more processors, cause the computer system to update the one or more first neural networks based, at least in part, on feedback generated by the carrier as a result of providing the procedure.

15. The set of non-transitory computer-readable storage medium of claim 13, wherein the content is a modification of what the recipient sent to indicate the issue.

16. The set of non-transitory computer-readable storage medium of claim 13, wherein the instructions that cause the computer system to generate the contact further include instructions that cause the computer system to provide a chat interface for the recipient and the carrier.

17. The set of non-transitory computer-readable storage medium of claim 13, wherein the one or more third neural networks comprise a transformer neural network.

18. The set of non-transitory computer-readable storage medium of claim 13, wherein the instructions further comprise instructions that, as a result of being executed by the one or more processors, cause the computer system to update the profile settings based, at least in part, on feedback generated by either the carrier or the recipient as a result of providing the procedure to the carrier.

19. The set of non-transitory computer-readable storage medium of claim 13, wherein the information indicates a location of a device associated with the carrier.

20. The set of non-transitory computer-readable storage medium of claim 13, wherein the instructions further comprise instructions that, as a result of being executed by the one or more processors, cause the computer system to translate, using a transformer neural network, the content to a language that is indicated in the profile settings.
